(19) United States
(12) Patent Application Publication
(10) Pub. No.: US 2026/0032581 A1
(43) Pub. Date: Jan. 29, 2026

(54) POWER SAVINGS BASED ON SPECTRUM ACCESS SYSTEM SUSPENSION FOR CITIZENS BROADBAND RADIO SERVICE NETWORK

(71) Applicant: Charter Communications Operating, LLC, St. Louis, MO (US)

(72) Inventors: Saran Khalid, Denver, CO (US); MohammedYusuf M. Shaikh, Aurora, CO (US); Perwaiz Akhtar, Aurora, CO (US)

(73) Assignee: Charter Communications Operating, LLC, St. Louis, MO (US)

(21) Appl. No.: 18/784,295

(22) Filed: Jul. 25, 2024

(51) Int. Cl. H04W 52/02

(52) U.S. Cl. CPC H04W 52/0206

(57) ABSTRACT

Methods and systems for saving power in response to receiving a grant suspension at a Citizens Broadband Radio Service (CBRS) device (CBSD). A method for power savings in a wireless network using Citizens Broadband Radio Service (CBRS) spectrum includes receiving, by a power saving engine from a spectrum access system (SAS), CBRS spectrum suspension commands, generating, by the power saving engine, a suspension list of CBRS devices (CBSDs) impacted by the CBRS spectrum suspension commands, and sending, by the power saving engine to service provider components, the suspension list to turn off power for the CBSDs on the suspension list.

### TECHNICAL FIELD

This disclosure relates to wireless communications. More specifically, power saving technique when a Citizens Broadband Radio Service (CBRS) grant is suspended by a spectrum access system for use by a base station.

### BACKGROUND

Wireless telecommunications or radio access technologies (RATs) generally use licensed radio frequency spectrum for communications between mobile devices and wireless telecommunications networks. For example, licensed spectrum is used for third generation (3G), fourth generation (4G), and fifth generation (5G) wireless communications. Wireless telecommunications technologies may also use unlicensed spectrum.

Citizens Broadband Radio Service (CBRS) spectrum is a type of unlicensed spectrum or shared radio frequency spectrum which is shared between multiple entities including government users (such as the military), licensed users, and non-licensed users. CBRS is a multitiered wireless band between 3.550 MHz and 3.700 MHz. In particular, CBRS is a three-tiered access framework including incumbent users (i.e., federal, military, and the like), priority access users (winning auction bidders) who have Priority Access Licenses (PALs) to CBRS spectrum, and general authorized access (GAA) users, where the general users are permitted to use any portion of the CBRS spectrum not assigned to a higher tier user and may also operate opportunistically on unused priority access spectrum. Availability of CBRS spectrum dynamically changes depending on use by higher priority entities. Higher tier users are protected from lower tier users using a centralized spectrum access system (SAS), which may be a federal or commercial entity. The SAS authorizes or grants spectrum to access points known as CBRS Devices (CBSDs) and performs interference management to protect higher tier users. This protection may include, for example, dropping CBSDs which are general authorized access users. In summary, CBRS is an interference limited network which means that the performance of the network and the data sent to CBRS subscribers is limited by the amount of interference the CBRS users or subscribers experience in the frequency band of operation.

The SAS suspends grant(s) at CBSD(s) when there is higher tier and/or incumbent usage on the CBRS spectrum being used by the CBSD(s). The CBSD(s) radios stop transmissions in response to receiving the grant suspension(s). The suspension(s) can range from minutes to hours to days. Suspension(s) can cause several radios to go out of service at cell level as well as at the sector level. In either case, the CBSD(s) can no longer transmit and are unable to carry traffic. In the suspended state, CBSD(s) are still online i.e., the CBSD(s) have connectivity back to a service provider system, backhaul, and/or other similar systems. However, the CBSD(s) are forbidden to transmit. Under these situations, the CBSD(s) continue to draw power from a power source despite not transmitting. For example, a base station may use 90 watts when in service and 76 watts when not transmitting. This can add up due to the number of base stations deployed in a network. This is not an energy efficient or environmentally friendly.

### SUMMARY

Disclosed is a system and method for saving power based on spectrum access system suspensions of one on more channels in a Citizens Broadband Radio Service (CBRS) system. In implementations, a method for power savings in a wireless network using Citizens Broadband Radio Service (CBRS) spectrum includes receiving, by a power saving engine from a spectrum access system (SAS), CBRS spectrum suspension commands, generating, by the power saving engine, a suspension list of CBRS devices (CBSDs) impacted by the CBRS spectrum suspension commands, and sending, by the power saving engine to service provider components, the suspension list to turn off power for the CBSDs on the suspension list.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a wireless network architecture in accordance with embodiments of this disclosure.

FIG. 2 is a diagram of an example of the wireless network in the wireless network architecture of FIG. 1 in accordance with embodiments of this disclosure.

FIG. 3 is a flow diagram of an example of a system saving power based on spectrum access system suspensions in accordance with embodiments of this disclosure.

FIG. 4 is a flow diagram of an example of a system saving power based on spectrum access system suspensions in accordance with embodiments of this disclosure.

FIG. 5 is a flowchart of an example method for saving power based on spectrum access system suspensions in accordance with embodiments of this disclosure.

FIG. 6 is a flowchart of an example method for saving power based on spectrum access system suspensions in accordance with embodiments of this disclosure.

FIG. 7 is a block diagram of an example of a device in accordance with embodiments of this disclosure.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU) s, one or more graphics processing units (GPU) s, one or more digital signal processors (DSP) s, one or more application specific integrated circuits (ASIC) s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein is a system and method for saving power based on spectrum access system suspensions of one on more channels in a Citizens Broadband Radio Service (CBRS) system.

In implementations, a spectrum access system (SAS) power save trigger engine (SPST) can subscribe to messages, including suspension messages, from the SAS. The suspension messages indicate which channels (where channels are a range of frequency bandwidths) are suspended. In implementations, the SAS may not provide alternative channel(s) for use by the service provider, base station(s), and/or cable modem(s). The SPST can determine whether all channels or channel(s) assigned to a service provider, base station(s), and/or cable modem(s) are suspended. The SPST can generate a list of base station(s) and/or cable modem(s) which are suspended and communicate the list to a cable modem termination system (CMTS). The CMTS can instruct a power node switch(es) to turn off the base station(s) and/or cable modem(s) which are on the list. In implementations, an alarm notification can be sent to a user that the base station(s) and/or cable modem(s) have been turned off.

In implementations, the SPST can monitor the messages to determine whether the suspensions have been lifted or restored, either partially or fully. In the event of partial restoration, the SPST can generate a list of base station(s) and/or cable modem(s) which can be turned on. The CMTS can instruct the power node switch(es) to turn on the base station(s) and/or cable modem(s) which are on the list. In implementations, an alarm notification can be sent to a user that the base station(s) and/or cable modem(s) have been turned on.

In implementations, the methods and systems herein provide mechanisms to turn off the base station(s), cable modem(s), and/or radios to ensure the power consumption remains minimal when SAS suspends transmission on one or more channels due to incumbent activity and/or otherwise.

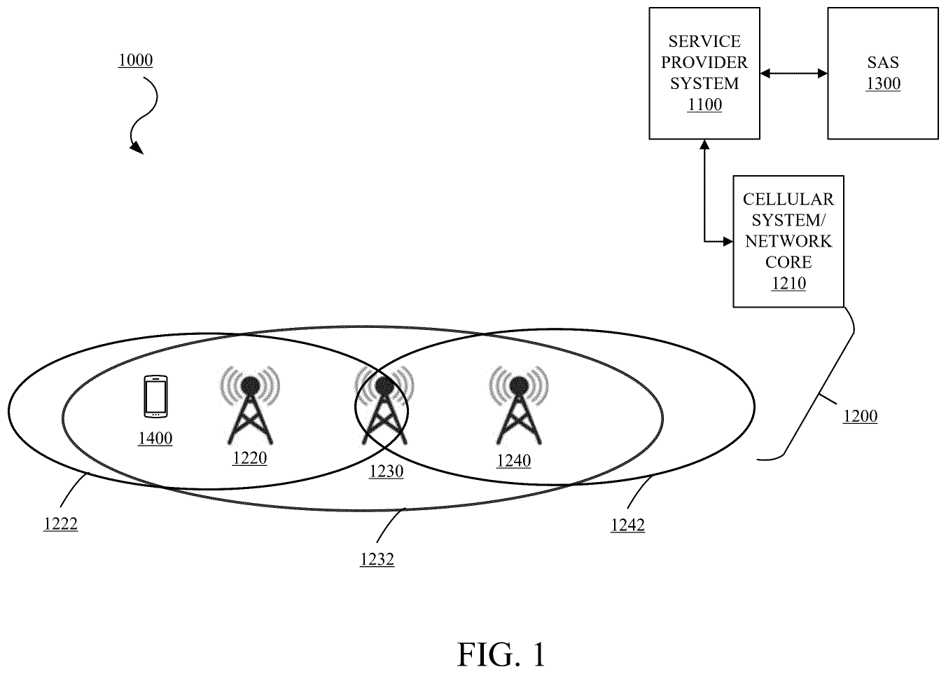

FIG. 1 is a diagram of an example wireless network architecture 1000. The wireless network architecture 1000 can include, but is not limited to, a service provider system 1100, a wireless or cellular system or network (collectively “wireless system”) 1200, and a SAS 1300. The wireless network architecture 1000 can implement any wireless technology including, but not limited to, third generation (3G), fourth generation (4G), and fifth generation (5G) wireless communications and/or networks, and CBRS or shared spectrum wireless technologies and/or networks. In implementations, the wireless network architecture 1000 can be a multiple systems operator (MSO) network, a hybrid mobile virtual network operator (HMNO) network where a service provider, which owns and operates the service provider system 1100, can operate the wireless system 1200 as a mobile virtual network operator (MVNO), and/or combinations thereof. The number of components shown herein are illustrative and there may be more or less in the wireless network architecture 1000. The wireless network architecture 1000 and the components therein may include other elements which may be desirable or necessary to implement the devices, systems, and methods described herein. However, because such elements and steps do not facilitate a better understanding of the disclosed embodiments, a discussion of such elements and steps may not be provided herein.

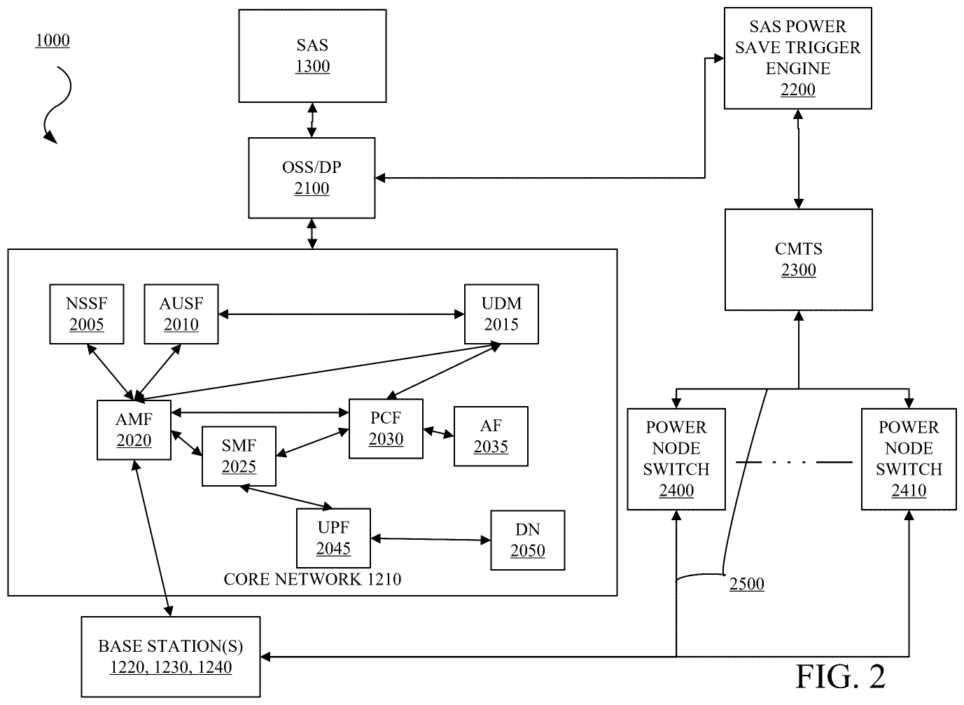

Referring now also to FIG. 2, the wireless system 1200 can include various functional components to address mobility management, authentication, session management, and other related functions with respect to, for example, one or more base stations 1220, 1230, and 1240. The wireless system 1200 can include, but is not limited to, a core network 1210 and the one or more base stations 1220, 1230, and 1240. Each of the one or more base stations 1220, 1230, and 1240 can be an access point, an access node, a gNodeB, cable modem/router/integrated devices, small cell base stations, low-powered cellular radio access nodes, small, low-power base stations, and/or like device which enables radio communications access between a mobile device 1400 and other devices in wireless coverage areas 1222, 1232, and 1242 of the one or more base stations 1220, 1230, and 1240, respectively. Each of the one or more base stations 1220, 1230, and 1240 can support wireless communications via one or more of the 3G, the 4G, the 5G, and CBRS wireless technologies and/or networks. In the instance that a base station 1220, 1230, and 1240, 1250, 1260, and 1270 uses or supports the CBRS spectrum, the base station 1220, 1230, and 1240, 1250, 1260, and 1270 can be, in part, a CBSD, which has been granted or authorized CBRS spectrum (e.g., a channel(s)) by the SAS 1300.

In implementations, the core network 1210 can include, but is not limited to, a Network Slice Selection Function (NSSF) 2005, an Authentication Server Function (AUSF) 2010, a Unified Data Management (UDM) 2015, an Access and Mobility management Function (AMF) 2020, a Session Management Function (SMF) 2025, a Policy Control Function (PCF) 2030, an Application Function (AF) 2035, a User Plane Function (UPF) 2045, and a Data Network (DN) 2050. The core network 1210 can function as described in the 3rd Generation Partnership Project (3GPP) specifications, which are incorporated herein by reference as if set forth herein. In implementations, the NSSF 2005 can handle network slice functions, the AUSF 2010 can handle authentication functions, the UDM 2015 can handle security credentials, the AMF 2020 can handle control plane functions and connection and management mobility tasks, the SMF 2025 can handle calls and sessions, the PCF 2030 can handle processes to ensure that the user data traffic does not exceed the negotiated bearer(s) capacities, the AF 2035 can control application(s), the UPF 2045 can handle the user data, and the DN 2050 can act as a user data repository.

The service provider system 1100 can include various functional components to address mobility management, authentication, session management, and other related functions with respect to, for example, the one or more base stations 1220, 1230, and 1240. The service provider system 1100 can include, but is not limited to, an operations support system (OSS)/domain proxy (DP) 2100, a SPST engine 2200, a cable modem termination system (CMTS) powering and switching 2300, and one or more power node switch(es) 2400 and 2410. In implementations, the one or more base stations 1220, 1230, and 1240, the CMTS 2300, and the one or more power node switch(es) 2400 and 2410 are connected via a hybrid-fiber-coaxial (HFC) infrastructure 2500 implementing Data Over Cable Service Interface Specification (DOCSIS). In implementations, the one or more base stations 1220, 1230, and 1240 are installed on strand which gets its power from local power supplies i.e., powering infrastructure for DOCSIS plant nodes. That is, the one or more base stations 1220, 1230, and 1240 are installed on DOCSIS plant and draws power from the same source of energy. In implementations, the service provider can have PAL licenses and can operate on GAA in a CBRS network. In implementations, the OSS 2100 and the SPST engine 2200 can be logically separate, logically integrated, physically separate, physically integrated, and/or combinations thereof. In implementations, the SPST engine 2200 can be a server, a cloud based platform, distributive, and/or combinations thereof.

The OSS 2100 can work with the wireless system 1200, the core network 1210, the SPST engine 2200, the SAS 1300, the CMTS 2300, the one or more power node switch(es) 2400 and 2410, and the other components in the service provider system 1100 to power down one or more base stations when one or more channels are suspended by the SAS 1300. In implementations, the OSS 2100 can work with the wireless system 1200, the core network 1210, the SPST engine 2200, the SAS 1300, the CMTS 2300, the one or more power node switch(es) 2400 and 2410, and the other components in the service provider system 1100 to power up one or more base stations when the one or more suspended channels are partially or fully restored by the SAS 1300.

The SPST engine 2200 can work with the OSS 2100 to subscribe to and receive suspension related messages from the SAS 1300. The SPST engine 2200 can review the suspension related messages to determine which, if any, base stations are affected by the suspension orders. This can include, but is not limited to, determining that the suspended channels effectively result in one or more base stations being operationally off with respect to transmitting data or traffic. The SPST engine 2200 can generate a list and/or otherwise notify the CMTS 2300 to turn off the impacted base station(s). In implementations, the SPST engine 2200 can generate a list and/or otherwise notify the CMTS 2300 to turn on base station(s) when appropriate.

The CMTS 2300 can provide cable, television, Internet, voice, and like services to premises, residences, offices, and the like (collectively “premises”) via the base stations 1220, 1230, and 1240. The CMTS 2300 can work with the SPST engine 2200 and the one or more power node switch(es) 2400 and 2410 to turn on or off base station(s) as appropriate.

The one or more power node switch(es) 2400 and 2410 can work with the CMTS 2300 to turn on or off the base stations. The one or more power node switch(es) 2400 and 2410 can be a software switch, digital switch, multiplexor, and/or similar device, where each power node switch can be connected to one or more base stations. In implementations, the one or more power node switch(es) 2400 and 2410 can be integrated with the CMTS 2300, be standalone devices, and/or combinations thereof.

The SAS 1300 enables access to the CBRS spectrum and dynamically manages the spectrum for optimal use, efficiency, and compliance with CBRS rules. The SAS 1300 communicates with each base station 1220, 1230, and 1240 (which can be a CBSD or which supports CBRS) for registration, grant allocation/deallocation and interference management. The SAS 1300 can perform interference analysis based on the power measurements received from mobile device(s) and make allocation and deallocation decisions based on the interference. The SAS 1300 may be operated by a commercial, federal entity, or some combinations thereof.

The mobile device 1400 can be, but is not limited to, Internet of Thing (IOT) devices, sensors, end user devices, cellular telephones, Internet Protocol (IP) devices, mobile computers, laptops, handheld computers, personal media devices, smartphones, notebooks, notepads, and the like, which can be provisioned for operation with a MSO, a MVNO, and/or service provider, can be provisioned for direct communication with each other and other mobile devices, and can be provided and provisioned by a service provider to operate in 3G, 4G, 5G, CBRS, and/or other wireless communication technologies and/or networks.

Operationally, at least one of the base stations 1220, 1230, and 1240 supports CBRS and is performing as a CBSD. In this instance, at least one of the base stations 1220, 1230, and 1240 has received a grant to use CBRS spectrum (one or more channels) from the SAS 1300. The SPST engine 2200 has subscribed to suspension related messages from the SAS 1300 via the OSS 2100. In implementations, the suspension related messages can include, but is not limited to, suspension orders, restoration orders, and/or combinations thereof. In implementations, the SPST engine 2200 can subscribe to all messages from the SAS 1300 via the OSS 2100 and determine the relevant suspension orders, restoration orders, and/or combinations thereof.

At some point in time, the SAS 1300 sends a suspension order(s) or command(s) to the service provider system 1100 and/or the OSS 2100. The suspension order(s) or command(s) starts a defined period of time within which a base station needs to stop transmitting on the previously granted CBRS spectrum. The SPST engine 2200 can receive and review the suspension order(s) or command(s) to determine if there are any impacted base stations which should be turned off. This can happen if all the channels have been suspended, if the channels associated with a base station are suspended, if the channels associated with the service provider are suspended, and/or combinations thereof. In these instances, the SAS 1300 has provided no alternative channels to transmit on. The SPST engine 2200 can inform the CMTS 2300, which in turn can inform the one or more power node switch(es) 2400 and 2410. The one or more power node switch(es) 2400 and 2410 can then turn off power to the impacted base stations.

In implementations, the SPST engine 2200 can receive and review restoration order(s) or command(s) and determine which base station(s) can be turned on. The SPST engine 2200 can inform the CMTS 2300, which in turn can inform the one or more power node switch(es) 2400 and 2410. The one or more power node switch(es) 2400 and 2410 can then turn on power to the appropriate base stations.

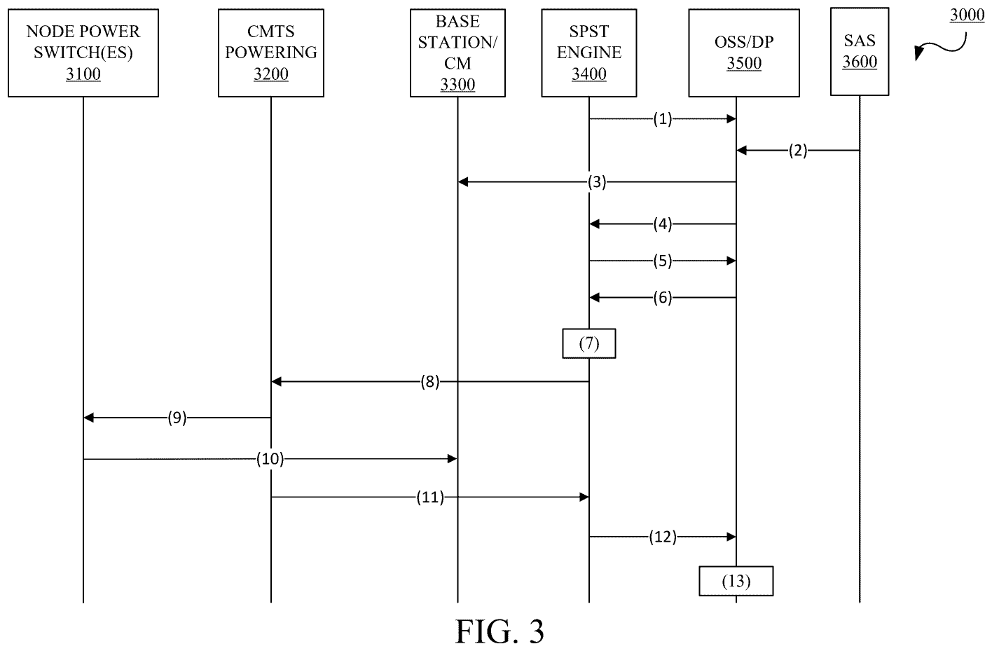

FIG. 3 is a flow 3000 of an example of a system using a power saving based on SAS suspension method and device in accordance with embodiments of this disclosure. The flow 3000 is performed between one or more power node switches 3100, a CMTS 3200, one or more base stations 3300, a SPST engine 3400, an OSS 3500, and a SAS 3600. Each of the components listed in FIG. 3 can function as described herein with respect to FIGS. 1 and 2.

In the flow 3000, the SPST engine 3400 can subscribe with the OSS 3500 to send SAS messages to the SPST engine 3400 (1). The SAS 3600 can send suspension order(s) to the OSS 3500 (2). The OSS 3500 can forward the suspension order(s) to the one or more base stations 3300 (3). The OSS 3500 can forward the suspension order(s) to the SPST engine 3400 (4). The SPST engine 3400 can request base station configuration information, such as but not limited to, channels being used, frequencies being used, bandwidth being used, and the like from the OSS 3500 (5). The OSS 3500 can send the requested base station configuration information to the SPST engine 3400 (6). The SPST engine 3400 can review the suspension order(s) to determine the impacted base stations (7). In implementations, the impacted base stations are base stations which have no operable channel(s) due to the suspension order(s). The SPST engine 3400 can generate a list of the impacted base stations (“suspended list”). The SPST engine 3400 can send the suspended list to the CMTS 3200 (8). The CMTS 3200 can send the suspended list to and/or act with respect to appropriate power node switches 3100 (9). The power node switches 3100 can switch off power at the appropriate base station(s) 3300 (10). The CMTS 3200 can notify the SPST engine 3400 that the power to the impacted base stations has been turned off (11). In implementations, the CMTS 3200 can confirm power off status using a variety of techniques. The SPST engine 3400 can notify the OSS 3500 that the power to the impacted base stations has been turned off (12). The OSS 3500 can send an alert and/or a notification to a user or user device (such as a mobile device) that certain base stations have been turned off (13).

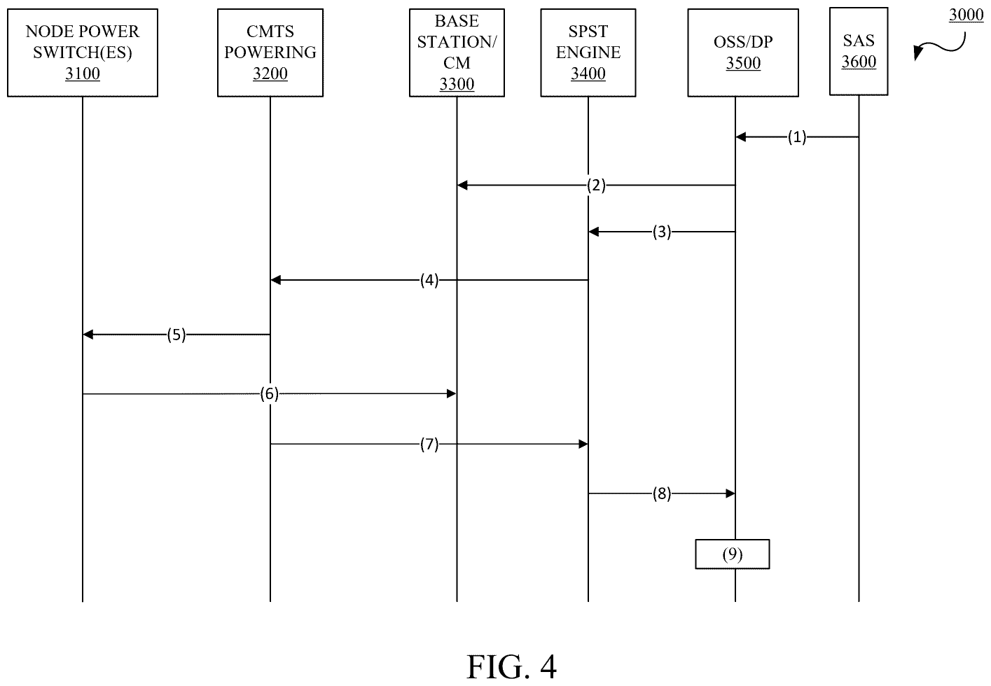

FIG. 4 is a flow 4000 of an example of a system using a power saving based on SAS suspension method and device in accordance with embodiments of this disclosure. The flow 4000 is performed between one or more power node switches 3100, a CMTS 3200, one or more base stations 3300, a SPST engine 3400, an OSS 3500, and a SAS 3600. Each of the components listed in FIG. 3 can function as described herein with respect to FIGS. 1 and 2 and with the flow 3000 described in FIG. 3. The flow 4000 assumes that the SPST engine 3400 has already subscribed with the OSS 3500 to send SAS messages to the SPST engine 3400. If not already subscribed, then the SPST engine 3400 can subscribe with the OSS 3500 to send SAS messages to the SPST engine 3400.

In the flow 4000, the SAS 3600 can send restoration or grant restored (“restoration”) order(s) to the OSS 3500 (1). The OSS 3500 can forward the restoration order(s) to the one or more base stations 3300 (2). The OSS 3500 can forward the restoration order(s) to the SPST engine 3400 (3). The SPST engine 3400 can review the restoration order(s) to determine which of impacted base stations can be turned on. In implementations, an impacted base station can be turned on as long as at least one channel has been restored. The SPST engine 3400 can generate a list of the impacted base station(s) to be restored (“restoration list”). The SPST engine 3400 can send the restoration list to the CMTS 3200 (4). The CMTS 3200 can send the restoration list to and/or act with respect to appropriate power node switches 3100 (5). The power node switches 3100 can switch on power at the appropriate base station(s) 3300 (6). The CMTS 3200 can notify the SPST engine 3400 that the power to the impacted base stations has been turned on (7). In implementations, the CMTS 3200 can confirm power on status using a variety of techniques. The SPST engine 3400 can notify the OSS 3500 that the power to the impacted base stations has been turned on (8). The OSS 3500 can send and/or clear an alert and/or a notification to a user or user device (such as a mobile device) that certain base stations have been turned on (9).

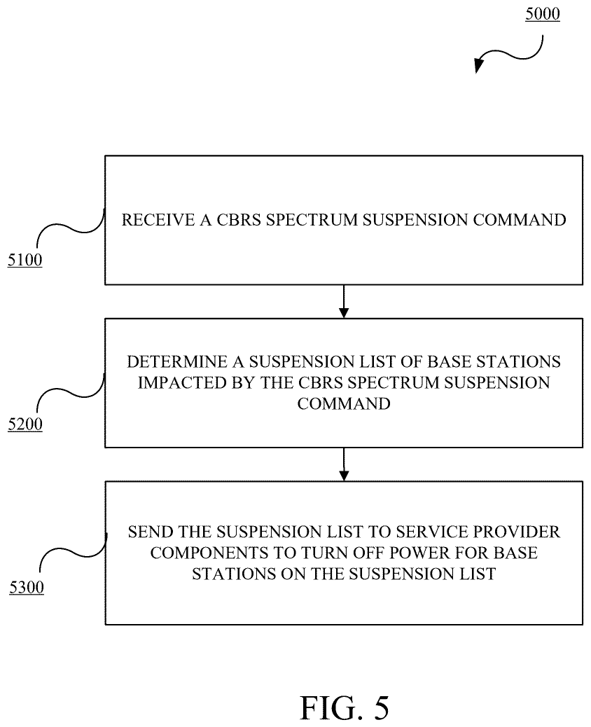

FIG. 5 is a flowchart of an example method 5000 for saving power in response to receiving a grant suspension at a Citizens Broadband Radio Service (CBRS) device (CBSD) in a CBRS network in accordance with embodiments of this disclosure. The method 5000 includes: receiving 5100 a CBRS spectrum suspension command; determining 5200 a suspension list of base stations impacted by the CBRS spectrum suspension command; and sending 5300 the suspension list to service provider components to turn off power for base stations on the suspension list. The method 5000 can be implemented, for example, in or by components described with respect to FIGS. 1-2 and in conjunction with any of the flows described with respect to FIGS. 3-4 and 6, as appropriate and applicable.

The method 5000 includes receiving 5100 a CBRS spectrum suspension command. A SPST or power saving engine or controller can subscribe to SAS messages via the OSS, where the SAS messages can at least include suspension commands. A CBRS spectrum can be shared spectrum, both of which are managed by the SAS or similar shared spectrum controller.

The method 5000 includes determining 5200 a suspension list of base stations impacted by the CBRS spectrum suspension command. The SPST engine can review the suspension orders against base station configuration received from the OSS to determine the impacted base stations.

The method 5000 includes sending 5300 the suspension list to service provider components to turn off power for base stations on the suspension list. The service provider components can include, but is not limited to, a CMTS and one or more power node switch(es). The service provider components can switch off power at a base station level in contrast to clusters or groups of base stations.

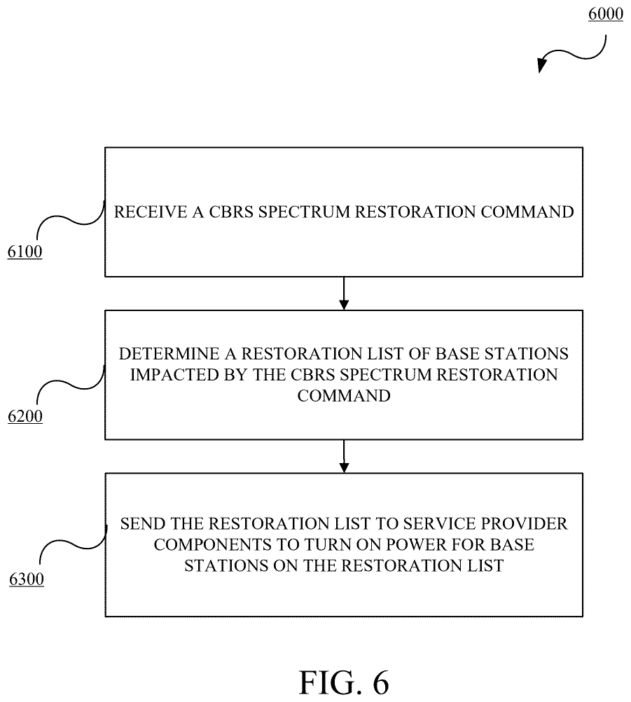

FIG. 6 is a flowchart of an example method 6000 for saving power in response to receiving a grant suspension at a Citizens Broadband Radio Service (CBRS) device (CBSD) in a CBRS network in accordance with embodiments of this disclosure. The method 5000 includes: receiving 6100 a CBRS spectrum restoration command; determining 6200 a restoration list of base stations impacted by the CBRS spectrum restoration command; and sending 6300 the restoration list to service provider components to turn on power for base stations on the restoration list. The method 6000 can be implemented, for example, in or by components described with respect to FIGS. 1-2 and in conjunction with any of the flows described with respect to FIGS. 3-5, as appropriate and applicable.

The method 6000 includes receiving 6100 a CBRS spectrum restoration command. A SPST engine or controller can subscribe to SAS messages via the OSS, where the SAS messages can at least include restoration commands. The restoration commands include CBRS spectrum that had been suspended by the SAS. A CBRS spectrum can be shared spectrum, both of which are managed by the SAS or similar shared spectrum controller.

The method 6000 includes determining 6200 a restoration list of base stations impacted by the CBRS spectrum restoration command. The SPST engine can review the restoration orders against base station configuration received from the OSS to determine which of the impacted base stations (those base stations that had been turned off due to a suspension order) can be turned on. For an impacted base station to be turned on, at least one channel has to be restored by the CBRS spectrum restoration command(s).

The method 6000 includes sending 6300 the restoration list to service provider components to turn on power for base stations on the restoration list. The service provider components can include, but is not limited to, a CMTS and one or more power node switch(es). The service provider components can switch on power at a base station level in contrast to clusters or groups of base stations.

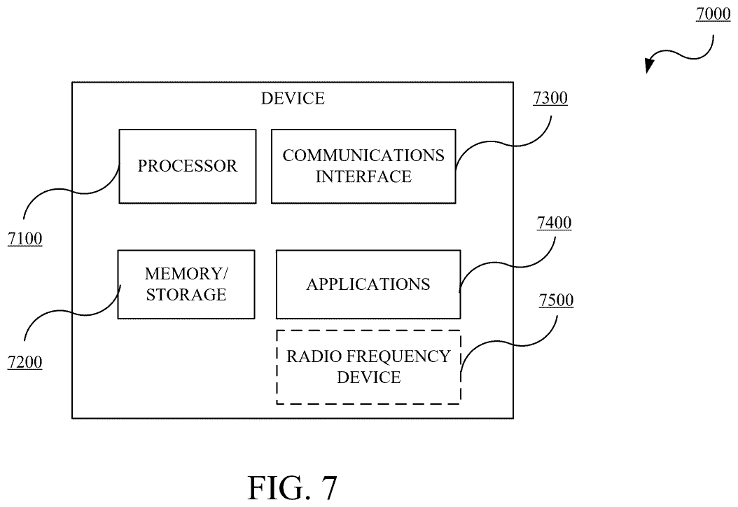

FIG. 7 is a block diagram of an example of a device 7000 in accordance with embodiments of this disclosure. The device 7000 may include, but is not limited to, a processor 7100, a memory/storage 7200, a communication interface 7300, applications 7400, and, if needed, a radio frequency device 7500. The device 7000 may include or implement, for example, the systems and components described with respect to FIGS. 1-4 and the implement the methods of FIGS. 5 and 6. The applicable or appropriate flows, techniques, or methods described herein may be stored in the memory/storage 7200 and executed by the processor 7100 in cooperation with the memory/storage 7200, the communications interface 7300, the applications 7400, and the radio frequency device 7500 (when applicable), as appropriate. The device 7000 may include other elements which may be desirable or necessary to implement the devices, systems, and methods described herein. However, because such elements and steps do not facilitate a better understanding of the disclosed embodiments, a discussion of such elements and steps may not be provided herein.

Disclosed is a method for saving power based on spectrum access system suspensions of one on more channels in a Citizens Broadband Radio Service (CBRS) system. In implementations, a method for power savings in a wireless network using Citizens Broadband Radio Service (CBRS) spectrum includes receiving, by a power saving engine from a spectrum access system (SAS), CBRS spectrum suspension commands, generating, by the power saving engine, a suspension list of CBRS devices (CBSDs) impacted by the CBRS spectrum suspension commands, and sending, by the power saving engine to service provider components, the suspension list to turn off power for the CBSDs on the suspension list.

In implementations, the method further includes subscribing, by the power saving engine with an operations support system, to spectrum access system messages including the CBRS spectrum suspension commands. In implementations, the method further includes receiving, by the power saving engine from an operations support system, configuration information for each of the CBSDs. In implementations, the generating further includes reviewing, by the power saving engine, the CBRS spectrum suspension commands in view of the configuration information for each of the CBSDs to determine the suspension list. In implementations, a CBSD is impacted if all CBRS spectrum granted to the CBSD by the SAS is suspended by the CBRS spectrum suspension commands. In implementations, the service provider components include a power node switch and the sending further includes powering down, by the power node switch, each of the CBSDs on the suspension list. In implementations, the method further includes sending, by an operations support system to a user device, that certain CBSDs have been powered down. In implementations, the method further includes receiving, by the power saving engine from the SAS, CBRS spectrum restoration commands, generating, by the power saving engine, a restoration list of CBSDs impacted by the CBRS spectrum restoration commands, and sending, by the power saving engine to the service provider components, the restoration list to turn on power for the CBSDs on the suspension list. In implementations, spectrum access system messages subscribed to by the power saving engine include the CBRS spectrum restoration commands. In implementations, a second occurrence of the generating further includes reviewing, by the power saving engine, the CBRS spectrum restoration commands in view of configuration information for each of the CBSDs to determine the restoration list. In implementations, the method further includes a CBSD is restored if at least some of the CBRS spectrum granted to the CBSD and suspended by the SAS is restored by the CBRS spectrum restoration commands. In implementations, the service provider components include a power node switch and the sending further includes powering up, by the power node switch, each of the CBSDs on the restoration list. In implementations, the method further includes sending, by an operations support system to a user device, that certain CBSDs have been powered up.

Disclosed is a system for saving power based on spectrum access system suspensions of one on more channels in a Citizens Broadband Radio Service (CBRS) system. In implementations, a system includes a power saving controller configured to receive, from a spectrum access system (SAS), shared channel suspension orders, determine which base stations are impacted by the shared channel suspension orders, and notify service provider components to turn off power for each base station impacted by the shared channel suspension orders. In implementations, the power saving controller further configured to subscribe to spectrum access system messages via an operations support system, wherein the spectrum access system messages include the shared channel suspension orders. In implementations, the power saving controller further configured to receive, from an operations support system, channel information for each of the base stations, and review the shared channel suspension orders against the channel information to determine which of the base stations are impacted by the shared channel suspension orders, wherein a base station is impacted if all shared channels granted to the base station by the SAS are suspended by the shared channel suspension orders. In implementations, the service provider components include a power node switch and the power node switch is configured to power down each base station impacted by the shared channel suspension orders. In implementations, the power saving controller further configured to receive, from the SAS, shared channel restoration orders, determine which base stations are restorable by the shared channel restoration orders, and notify the service provider components to turn on power for each restorable base. In implementations, the power saving controller further configured to receive, from an operations support system, channel information for each base station, and review the shared channel restoration orders against the channel information to determine which of the base stations are restorable, wherein a base station is restorable if at least one shared channel granted to the base station by the SAS and suspended is restored by the shared channel restoration orders. In implementations, the service provider components include a power node switch and the power node switch is configured to power up each restorable base station.

Although some embodiments herein refer to methods, it will be appreciated by one skilled in the art that they may also be embodied as a system or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for power savings in a wireless network using Citizens Broadband Radio Service (CBRS) spectrum, the method comprising:
receiving, by a power saving engine from a spectrum access system (SAS), CBRS spectrum suspension commands;
generating, by the power saving engine, a suspension list of CBRS devices (CBSDs) impacted by the CBRS spectrum suspension commands; and
sending, by the power saving engine to service provider components, the suspension list to turn off power for the CBSDs on the suspension list.

2. The method of claim 1, further comprising:
subscribing, by the power saving engine with an operations support system, to spectrum access system messages including the CBRS spectrum suspension commands.

3. The method of claim 1, further comprising:
receiving, by the power saving engine from an operations support system, configuration information for each of the CBSDs.

4. The method of claim 3, wherein the generating further comprising:
reviewing, by the power saving engine, the CBRS spectrum suspension commands in view of the configuration information for each of the CBSDs to determine the suspension list.

5. The method of claim 1, wherein a CBSD is impacted if all CBRS spectrum granted to the CBSD by the SAS is suspended by the CBRS spectrum suspension commands.

6. The method of claim 1, wherein the service provider components include a power node switch and the sending further comprising:
powering down, by the power node switch, each of the CBSDs on the suspension list.

7. The method of claim 1, further comprising:
sending, by an operations support system to a user device, that certain CBSDs have been powered down.

8. The method of claim 1, further comprising:
receiving, by the power saving engine from the SAS, CBRS spectrum restoration commands;
generating, by the power saving engine, a restoration list of CBSDs impacted by the CBRS spectrum restoration commands; and
sending, by the power saving engine to the service provider components, the restoration list to turn on power for the CBSDs on the suspension list.

9. The method of claim 8, wherein spectrum access system messages subscribed to by the power saving engine include the CBRS spectrum restoration commands.

10. The method of claim 8, wherein a second occurrence of the generating further comprising:
reviewing, by the power saving engine, the CBRS spectrum restoration commands in view of configuration information for each of the CBSDs to determine the restoration list.

11. The method of claim 10, wherein a CBSD is restored if at least some of the CBRS spectrum granted to the CBSD and suspended by the SAS is restored by the CBRS spectrum restoration commands.

12. The method of claim 8, wherein the service provider components include a power node switch and the sending further comprising:
powering up, by the power node switch, each of the CBSDs on the restoration list.

13. The method of claim 8, further comprising:
sending, by an operations support system to a user device, that certain CBSDs have been powered up.

14. A system, comprising:
a power saving controller configured to:
receive, from a spectrum access system (SAS), shared channel suspension orders;
determine which base stations are impacted by the shared channel suspension orders; and
notify service provider components to turn off power for each base station impacted by the shared channel suspension orders.

15. The system of claim 14, the power saving controller further configured to:
subscribe to spectrum access system messages via an operations support system, wherein the spectrum access system messages include the shared channel suspension orders.

16. The system of claim 14, the power saving controller further configured to:
receive, from an operations support system, channel information for each of the base stations; and
review the shared channel suspension orders against the channel information to determine which of the base stations are impacted by the shared channel suspension orders,
wherein a base station is impacted if all shared channels granted to the base station by the SAS are suspended by the shared channel suspension orders.

17. The system of claim 14, wherein the service provider components include a power node switch and the power node switch is configured to:
power down each base station impacted by the shared channel suspension orders.

18. The system of claim 14, the power saving controller further configured to:
receive, from the SAS, shared channel restoration orders;
determine which base stations are restorable by the shared channel restoration orders; and
notify the service provider components to turn on power for each restorable base.

19. The system of claim 18, the power saving controller further configured to:
receive, from an operations support system, channel information for each base station; and
review the shared channel restoration orders against the channel information to determine which of the base stations are restorable,
wherein a base station is restorable if at least one shared channel granted to the base station by the SAS and suspended is restored by the shared channel restoration orders.

20. The system of claim 18, wherein the service provider components include a power node switch and the power node switch is configured to:
power up each restorable base station.
